(19) United States
(12) Patent Application Publication
(10) Pub. No.: US 2007/0053794 A1
(43) Pub. Date: Mar. 8, 2007

(54) Sample identification system having plural readers

(75) Inventors: Antonio M. Perez, Cooper City, FL (US); Eduardo Jose Delgado, Miami Lakes, FL (US)

Correspondence Address: BECKMAN COULTER, INC., P.O. BOX 169015, MAIL CODE 32-A02, MIAMI, FL, 33116-9015, US

(73) Assignee: Beckman Coulter, Inc., Fullerton, CA (US)

(21) Appl. No.: 11/222,315

(22) Filed: Sep. 8, 2005

(51) Int. Cl. G01N 21/00

(52) U.S. Cl. 422/82.05

(57) ABSTRACT

A sample identification system that may be used to track and correlate a sample container in a laboratory analyzer or the like is set forth. The exemplary laboratory analyzer employs at least one carrier that supports at least one sample tube. The sample identification system includes a first optical reader that has a first field of view that is sufficient to expose the first optical reader to targeted visual indicia that identifies the carrier. The system further includes a second optical reader that has a second field of view that is sufficient to expose the second optical reader to targeted visual indicia identifying the sample tube held by the carrier. One or more decoders may be used to extract the identification information from the targeted visual indicia. The identification information then may be provided to a process controller, which may use the information for one or more predetermined purposes. One such purpose may be to use the identification information derived from the first and second readers to direct manipulation of the content of the sample tube. In various embodiments, the system may employ one or more masks to enhance the accuracy of the identification process. Further, the system may be adapted to replace a legacy identification system of an existing apparatus.

### BACKGROUND OF THE INVENTION

1. Technical Field

The present invention is generally directed to laboratory apparatus that are used in the analysis and/or manipulation of sample materials. More particularly, the present invention is directed to a sample identification system that is suitable for use in automated laboratory apparatus that are used in the analysis and/or manipulation of biological samples, such as blood, urine, etc.

2. Background Art

Manual, semi-automated and automated analyzers for measuring certain parameters of or otherwise manipulating a biological sample obtained from a patient are well-known. In such systems, the biological sample must be carefully tracked and correlated with either or both the patient and/or the particular process that is to be executed on the sample. Preferably, the tracking and correlation are automated to reduce the potential for human error.

One embodiment of a hematology analyzer in which a sample tube is identified during aspiration of blood contained in the tube is set forth in U.S. Pat. No. 4,609,017, entitled “Method and Apparatus for Transporting Carriers of Sealed Sample Tubes and Mixing the Samples” issued Sep. 2, 1986, to Coulter et al. In the analyzer disclosed in the '017 patent, a plurality of sealed blood sample tubes are housed in a carrier. Several of these carriers are vertically stacked with the sample tubes lying horizontally. The carriers are successively deposited onto a horizontal conveyor belt that moves them longitudinally in a semi-inverted mode as the carrier is transported from the stack to a sample aspiration station. Aspiration is accomplished by pushing a sample tube partially out from the carrier and into engagement with a sealed piercing tip of an aspiration probe. The tube is then retracted from the aspiration probe and returned to the carrier. The other tubes in the carrier are similarly aspirated as the carrier is stepped to align each tube with the aspiration probe.

Each sample tube includes a barcode that uniquely identifies the sample tube within the system. A barcode reader is fixed over the path of the carrier and the barcode for each sample tube is scanned as the sample tube is driven into engagement with the aspiration probe.

Commercial analyzers that are constructed to include many of the features of the apparatus disclosed in the '017 patent are available from Beckman Coulter, Inc. In some of these systems, both the sample tube and the corresponding carrier are identified with barcodes. One barcode is fitted on the carrier and is used to uniquely identify the carrier. Alternatively, a plurality of duplicate barcodes uniquely identifying the carrier may be positioned adjacent each sample tube position of the carrier. Another barcode is used to uniquely identify each individual sample tube within the corresponding carrier. A single barcode reader is used to read both the carrier barcode and the barcode of the sample tube. The barcode reader employs a non-scanning laser and receiver that are both fixed to the frame of the system. The motion of the carrier and the sample tube with respect to the laser and receiver are used to effect a barcode scan to identify the carrier and corresponding sample tube during an aspiration cycle in which an amount of the sample is aspirated from the tube.

The foregoing configuration is suitable for use in systems in which the barcodes are of high quality. However, when the sample tube with barcode labels or carrier barcode labels have a low contrast, poor edge quality, or other defects, the bar-code read rate performance rate can decreases. Accordingly, an improved sample identification system is needed.

### SUMMARY

A sample identification system that may be used to track and correlate a sample container in a laboratory analyzer or the like is set forth. The exemplary laboratory analyzer employs at least one carrier that supports at least one sample tube. The sample identification system includes a first optical reader that has a first field of view that is sufficient to expose the first optical reader to targeted visual indicia that identifies the carrier. The system further includes a second optical reader that has a second field of view that is sufficient to expose the second optical reader to targeted visual indicia identifying the sample tube held by the carrier. One or more decoders may be used to extract the identification information from the targeted visual indicia. The identification information then may be provided to a process controller, which may use the information for one or more predetermined purposes. One such purpose may be to use the identification information derived from the first and second readers to direct manipulation of the content of the sample tube. In various embodiments, the system may employ one or more masks to enhance the accuracy of the identification process. Further, the system may be adapted to replace a legacy identification system of an existing apparatus.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates one embodiment of an analyzer that may employ the improved sample identification system disclosed herein.

FIGS. 2 and 3 illustrate one manner in which the embodiment of the analyzer shown in FIG. 1 employs visual indicia for identification of the carrier and sample tubes.

FIG. 4 illustrates one embodiment of an improved sample identification system in an operative position with respect to the carrier and sample tubes.

FIG. 5 illustrates the embodiment of the improved sample identification system shown in FIG. 4 in a raised position to execute, for example, a maintenance operation.

FIG. 6 compares the natural fields of view and modified fields of view of the optical readers employed in one embodiment the sample identification system shown in FIG. 4.

FIG. 7 is a perspective view of one embodiment of a mask that may be used in the sample identification system shown in FIG. 4.

FIG. 8 illustrates one manner in which the improved sample identification system shown in FIG. 4 may be retrofitted on an apparatus to replace an existing legacy scanning system.

### DETAILED DESCRIPTION OF THE PREFERRED EMBODIMENTS

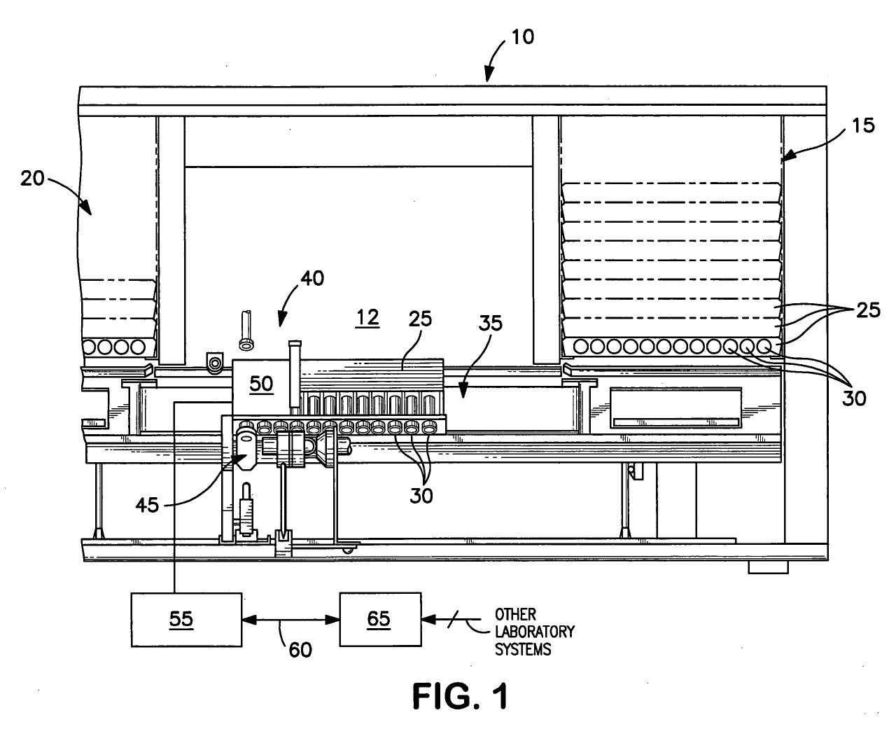

An apparatus that may employ an improved sample identification system constructed in accordance with one embodiment of the present invention is shown generally at 10 of FIG. 1. As shown, the apparatus 10 includes a sample processing section 12 that is bounded on its sides by a carrier input station 15 and a carrier output station 20. The carrier input station 15 includes a plurality of individual carriers 25 that are stacked vertically on top of one another. Each of the individual carriers 25 supports a corresponding plurality of sample tubes 30 that contain a biological material, such as blood, that is to be processed and/or analyzed by the apparatus 10.

Sample processing section 12 includes a conveyor system 35 that receives the individual carriers 25 for transport to a processing station 40, which may include a sample aspiration system 45 and a sample identification system 50. In this embodiment, conveyor system 35 transports the carriers 25 in a semi-inverted orientation as it concurrently rocks the carriers 25 to mix the contents of sample tubes 30. A more detailed description of such an exemplary system can be found in U.S. Pat. No. 4,609,017, entitled “Method and Apparatus for Transporting Carriers of Sealed Sample Tubes and Mixing the Samples”, issued to Coulter et al. on Sep. 2, 1986.

Once conveyor system 35 has transported the carrier 25 so that the first sample tube 30 of the carrier 25 is proximate aspiration system 45, the first sample tube 30 is driven downward into engagement with the aspiration system 45 and an amount of the material contained in the sample tube is aspirated. Sample identification system 50 reads separate visual indicia corresponding to the sample tube 30 being aspirated and the carrier 25 and provides the identification information to a processing unit, shown generally at 55. The read operation performed by the sample identification system 50 may take place prior to the aspiration, during the aspiration, or subsequent to the aspiration.

Processing unit 55 may comprise a programmable personal computer, programmable controller, embedded microcontroller, state machine, etc., and preferably includes one or more human interface devices (i.e., keyboard, display, mouse, etc.) to facilitate user interaction and definition of processing parameters. A communication link 60 may be used to transmit data to and/or receive data from a central processing system 65. Central processing system 65 may be used to control and keep track of the results from a plurality of analyzers/sample processors in the laboratory environment.

Processing unit 55 may use the data acquired during the read operation for a number of different purposes. For example, the acquired data may be used to correlate the analysis results with the proper sample tube. Further, the acquired data may be used to direct the processing station 40 to execute a particular process or processing sequence using the identified sample tube. This method of using the acquired data is particularly suitable in apparatus having a plurality of processing stations capable of executing different processes or apparatus having a single processing station/section capable of executing different processes with a plurality of processing tools. The particular process that is to be executed on the contents of an individual sample tube may be dictated by the central processing system 65 based on the sample tube identification information provided by processing unit 55. Further, processing unit 55 may be used to communicate the results of a process executed at processing station 40 along with the corresponding sample tube identification data to the central processing system 65. Other uses of the identification data are also contemplated, the foregoing uses being merely exemplary.

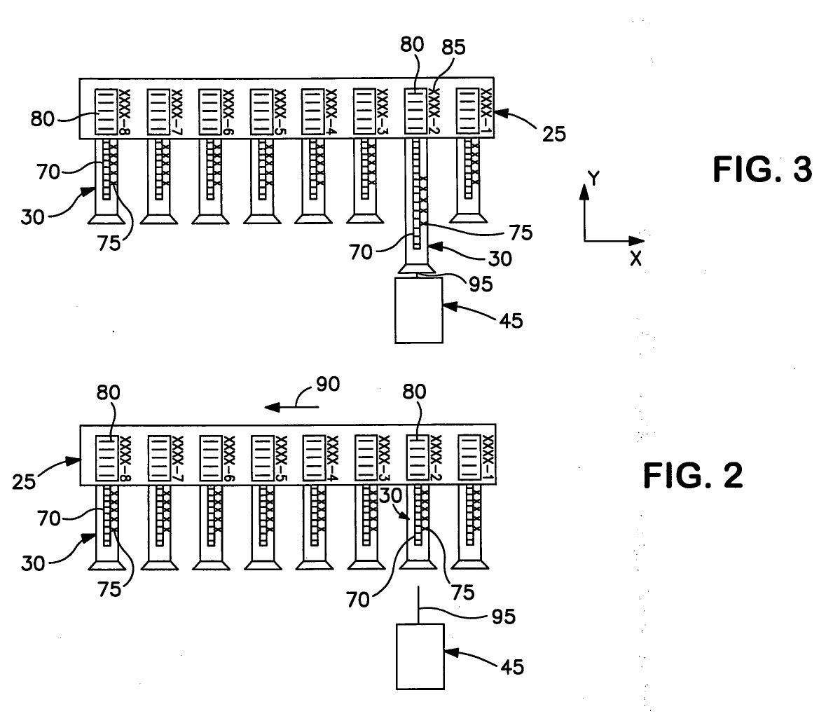

FIGS. 2 and 3 illustrate a plurality of sample tubes 30 supported in a carrier 25 and the corresponding visual indicia used to identify each. In the illustrated embodiment, each sample tube 30 includes a barcode label 70 that uniquely identifies the sample tube 30 in the analysis apparatus 10. The barcode label 70 also may include alphanumeric characters 75 that correspond to the barcode identification information. Similarly, carrier 25 includes one or more barcode labels 80 that identify the carrier 25 in the apparatus 10. In the illustrated embodiment, a plurality of barcode labels 80 are employed. Each barcode label 80 of this embodiment is disposed immediately adjacent a corresponding opening in the carrier 25 that receives a sample tube 30. Barcode labels 80 uniquely identify both the individual carrier 25 and the position of the corresponding sample tube 30 within the carrier 25. Again, the barcode labels 80 may include alphanumeric characters 85 that correspond to the identification data of the barcode.

The basic relative movement between a sample tube 30 and aspiration system 45 is also illustrated FIGS. 2 and 3. As shown, carrier 25 is first moved in the direction of arrow 90 to place the sample tube 30 in the second from last carrier slot in a position juxtaposed aspiration system 45. With the carrier 25 in this position, sample tube 30 is driven from its corresponding carrier slot and into engagement with a hollow needle/tube 95 of the aspiration system 45. An amount of material is then aspirated to or extracted from the interior of sample tube 30. Once aspiration is complete, the sample tube 30 is again driven into its corresponding carrier slot and the conveyor system 30 drives carrier 25 in the direction of arrow 90 until the sample tube in the last carrier slot is juxtaposed aspiration system 45. At this point, the aspiration cycle is repeated for the last sample tube 30.

Carrier 25 may be constructed in a variety of different manners. One construction that can be used to accommodate sample tubes 30 of different shapes and sizes is shown in U.S. Pat. No. 4,534,465, entitled “Cassette for Supporting Test Tubes of Different Diameters and/or Lengths”, issued Aug. 13, 1985, to Rothermel et al.

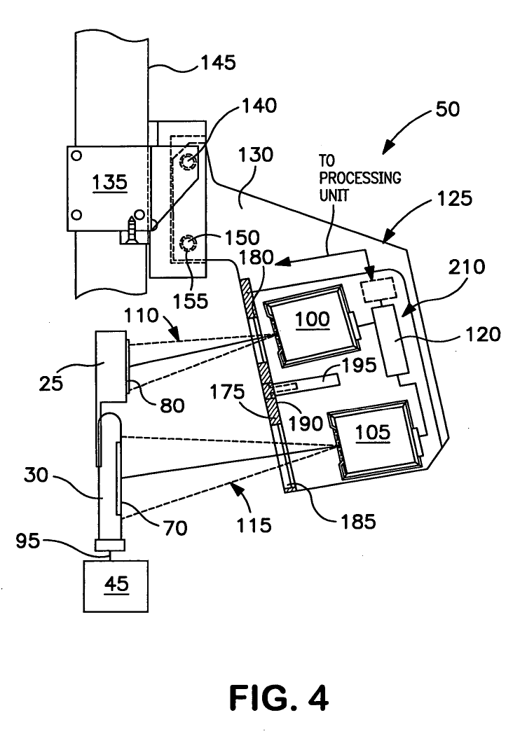

FIG. 4 illustrates a sample identification system 50 constructed in accordance with one embodiment of the present invention. In this embodiment, two optical readers 100 and 105 are employed. Optical reader 100 has a field of view, shown generally at 110, that is sufficient to expose the reader to visual indicia 80 identifying the carrier 25. The visual indicia 80 may take the form of the barcode labels shown in FIGS. 2 and 3. Optical reader 105 has a field of view, shown generally at 115, that is sufficient to expose the reader to visual indicia 70 identifying the sample tube 30 that is under process. The visual indicia 70 may take the form of the barcode labels shown in FIGS. 2 and 3, alphanumeric characters, etc.

In one embodiment, optical readers 100 and 105 are area scan cameras that provide a two-dimensional image of the visual indicia 70 and 80. Optical readers suitable for use in the illustrated system are available from Jadak Technologies, Inc., of Liverpool, N.Y. The two-dimensional images corresponding to visual indicia 70 and 80 are processed in a decoder 120. Decoder 120 analyzes the acquired images and extracts the identification information. The identification information may then be provided to processing unit 55 as a digital electronic identification signal that corresponds to the extracted identification information. Although decoder 120 may be located proximate optical readers 100 and 105 as shown, it may likewise be located at a location that is some distance from the readers or may be in the form of individual decoders that are integrated within and respectively associated with each of the readers 100 and 105.

As shown in FIG. 4, optical readers 100 and 105 may be fixed within a housing 125. Housing 125 includes an arm 130 that is secured to a support bracket 135 at a pivot joint 140. Support bracket 135, in turn, is in fixed positional alignment with the frame of apparatus 10. In the illustrated embodiment, support bracket 135 is directly secured with a pole 145 that is connected to the frame of apparatus 10.

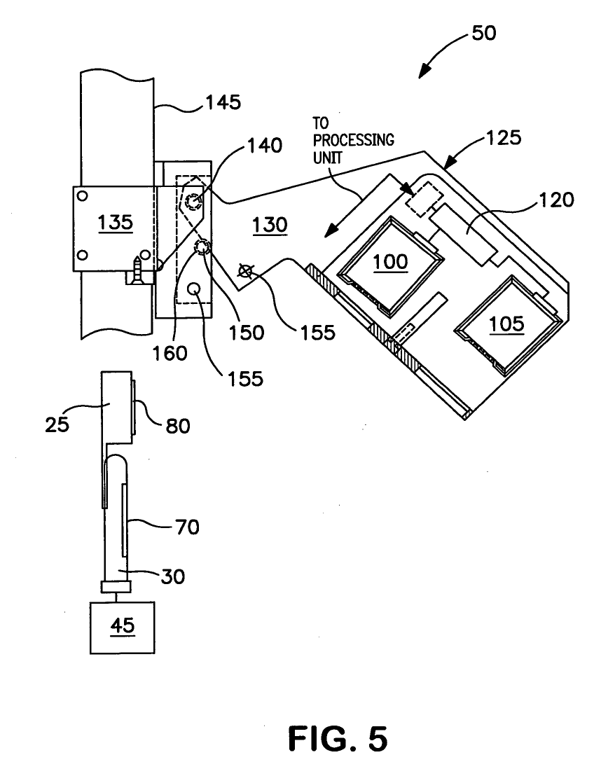

As apparent from a comparison of FIGS. 4 and 5, housing 125, and the components secured therein, can be rotated between the operative position shown in FIG. 4 and a maintenance position shown in FIG. 5. Rotation of the housing 125 occurs about pivot joint 140. While in the operative position, housing 125 is prevented from rotating about pivot joint 140 by a locking pin 150 that is secured within an aperture 155 that extends through bracket 135 and arm 130. When access to the components within the housing 125 is desired, the locking pin 150 is removed from aperture 155 thereby allowing the housing 125 to freely rotate about pivot joint 140 to the position shown in FIG. 5. The locking pin 150 may then be inserted into a further aperture 160 to prevent the housing 125 from rotating back to the operative position.

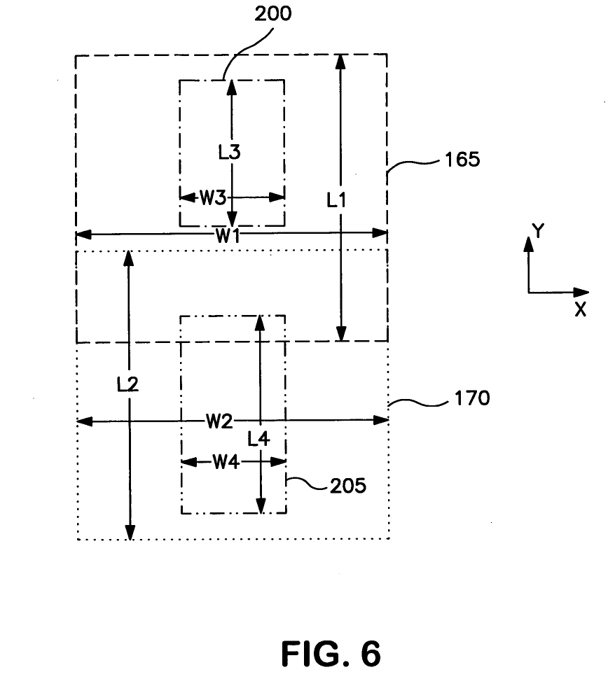

In many instances, space requirements will mandate the placement of optical readers 100 and 105 in close proximity with one another. However, such close placement can be problematic. One of the problems that may arise can be understood with reference to FIG. 6, which includes a plurality of different line types representing various fields of view encountered by readers 100 and 105 when the readers are positioned to detect the visual indicia 70 and 80. These fields of view represent the maximum horizontal and vertical range (see the x-y axes shown in FIG. 3) within which a reader can acquire a two-dimensional image. More particularly, optical reader 100 has a natural field of view designated by line 165 with respect to the carrier 25. The natural field of view 165 has a height L1 and a width W1. Similarly, optical reader 105 has a natural field of view designated by line 170 with respect to the sample tubes 30. The natural field of view 170 has a height L2 and a width W2.

There are several problems associated with the natural fields of view 165 and 170. Notably, the fields of view 165 and 170 are overlapping with one another. Still further, the widths W1 and W2 of the fields of view 165 and 170 are often significantly wider than the widths of the individual visual indicia 80 and 70 that are to be respectively read and decoded by optical readers 100 and 105 and decoder 120. As a result, the images generated by each optical reader 100 and 105 will include visual information from indicia that are adjacent the indicia that is to be acquired and decoded. In the illustrated example, optical reader 100 has a natural field of view 165 that will generate an image that includes the targeted visual indicia 80 at the particular carrier slot that is to be read and decoded as well as additional visual indicia. For example, additional visual indicia 80 may fall within the field of view 165 from adjacent carrier slots. Still further, additional visual indicia 70 from one or more sample tubes 30 that are vertically and/or horizontally adjacent to the targeted visual indicia 80 may fall within the field of view 165. Similarly, optical reader 105 has a natural field of view 170 that will generate an image that includes the targeted visual indicia 70 from the particular sample tube that is to be read and decoded as well as additional visual indicia. For example, additional visual indicia 70 may fall within the field of view 170 from sample tubes 30 contained in adjacent carrier slots. Still further, additional visual indicia 80 from one or more carrier slots that are vertically and/or horizontally adjacent to the targeted visual indicia 70 may fall within the field of view 170.

Images including extraneous visual indicia information beyond the particular visual indicia 70 and 80 that are targeted can result in misidentification of the targeted sample tube 30 and carrier 25. Software solutions to this problem can be difficult to implement and are not easily transferred between systems having different design criterion (i.e., reader placement, indicia type and location, etc.).

An alternative approach to addressing the field of view problems that may arise in a given implementation of the sample identification system 50 is shown and described in connection with FIGS. 4, 6 and 7. More particularly, the sample identification system 50 includes a mechanical mask 175 having a first aperture 180 spaced from the lens of optical reader 100 and a second aperture 185 spaced from the lens of optical reader 105. Generally stated, the mask 175 is designed to limit the natural fields of view 165 and 170 of the optical readers 100 and 105, respectively, and thereby reduce and/or eliminate extraneous visual indicia from the acquired images. By reducing and/or eliminating such extraneous visual indicia, the acquired images may be more easily processed and the likelihood that a sample tube/carrier will be misidentified is substantially reduced.

In the illustrated embodiment, mask 175 is in the form of a plate that is secured to a face of housing 125. Mask 175 also may include a centrally disposed opening 190 that accommodates an illumination lamp 195 that directs light toward one or both of the visual indicia 70 and 80.

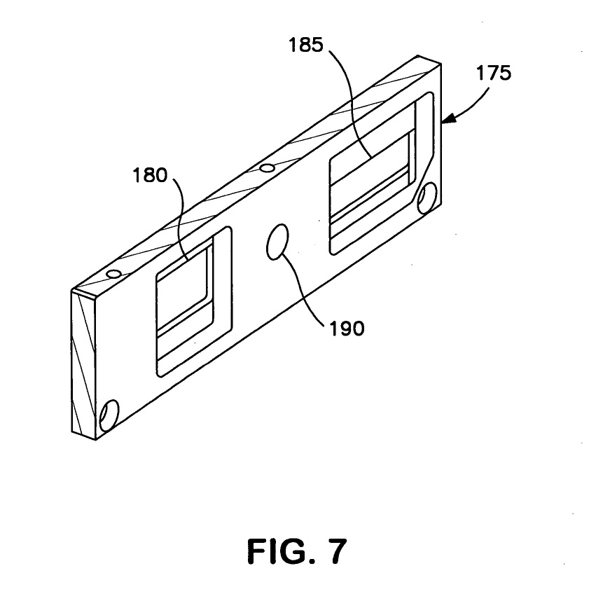

One construction of the mask 175 is represented in FIG. 7. As shown, apertures 180 and 185 may each be generally rectangular in shape. Since the particular design of the visual indicia 80 illustrated in FIGS. 2 and 3 is wider and shorter than the particular design of the visual indicia 70, aperture 180 is wider and shorter than aperture 185 in this construction. However, it will be recognized that other shapes and dimensions for the apertures 180 and 185 may be employed, provided that the desired limiting of the natural fields of view 165 and 170 is achieved.

The effect of using mask 175 can be understood with reference to FIG. 6. More particularly, the natural field of view 165 of optical reader 100 has been reduced to the modified field of view area enclosed by line 200. Similarly, the natural field of view 170 of optical reader 105 has been reduced to the modified field of view area enclosed by line 205. Modified field of view 200 has a length L3 and a width W3 that are substantially smaller than the length L1 and width W1 of the natural field of view 165 of reader 100. Preferably, the dimensions of the modified field of view 200 allow optical reader 100 to acquire a complete image of the targeted visual indicia 80 while concurrently precluding the reader from acquiring any identification information from adjacent, non-targeted visual indicia.

Likewise, modified field of view 205 has a length L4 and a width W4 that are substantially smaller than the length L2 and width W2 of the natural field of view 170 of reader 105. Preferably, the dimensions of the modified field of view 205 allow optical reader 105 to acquire a complete image of the targeted visual indicia 70 while concurrently precluding the reader from acquiring any identification information from adjacent, non-targeted visual indicia.

The sample identification system 50 may be adapted for retrofitting into an existing analysis apparatus having, for example, a single barcode scanner. As shown in FIG. 4, system 50 may be secured with an existing portion of the frame of the apparatus 10 by a support, such as bracket 135, so that the readers 100 and 105 are positioned to accurately acquire images of the targeted visual indicia.

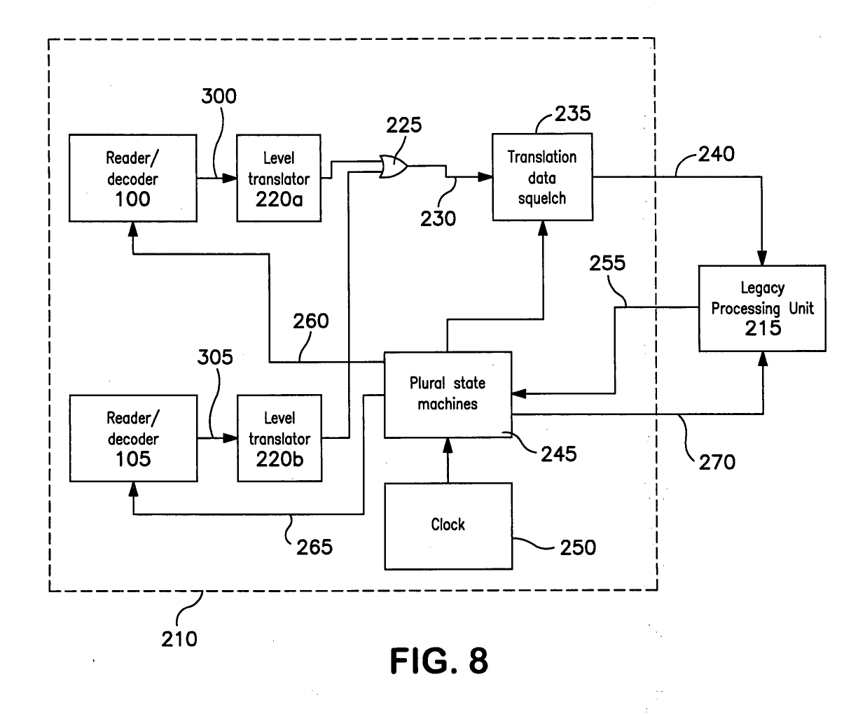

FIG. 8 shows one manner in which system 50 may be retrofitted into apparatus 10 with minimal, if any, impact on existing electronic hardware and software. To this end, the legacy scanning components and corresponding control circuitry (i.e., the single barcode scanning unit described above) are replaced by the components shown generally at 210. Legacy processing unit 215 may operate in the same manner as processing unit 55 described above. However, the legacy processing unit 215 has input/output signals that were used with the legacy scanning system. Accordingly, the legacy processing unit 215 is designed to transmit specific signals to initiate a barcode read cycle and to receive status signals indicating proper operation of the legacy scanning system. Further, the legacy processing unit 215 is designed to receive digital data corresponding to the targeted barcodes in a predetermined data format. In this example, data was provided to the legacy processing unit 215 in standard RS-232 format using the prior sample identification system. However, other signal and data formats may likewise have been used by the legacy processing unit and the corresponding system 210 is designed to interact with the legacy process unit using the existing signal and data formats.

System 210, as shown in FIG. 4, may be disposed in housing 125, and, as shown in FIG. 8, may include a pair of readers 100 and 105 that each also may include a corresponding decoder circuit. The output signals provided by readers 100 and 105 at lines 300 and 305, respectively, may be in the form of standard RS-232 signals. Since other portions of the updated system 210 may operate at a different logic signal level, such as TTL or the like, the standard RS-232 signals at lines 300 and 305 are provided to the inputs of corresponding level translator circuits 220a and 220b. The level translated signals from the output of the level translators 220a and 320b are provided to the input of a logical “OR” gate 225. The resulting logic signal at line 230 may be provided to the input of a further level translation circuit 235 for conversion from a logic level RS-232 signal to a standard level RS-232 signal at output line 240, which is provided as the data input to the legacy processing unit 215.

The generation and transmission of non-data signals between the legacy processing unit 215 and the readers/decoders 100 and 105 is coordinated by plural state machines 245 that cycle through their various states in response to a system clock 250 as well as one or more synchronous sample identification requests signals provided at output 255 of legacy processing unit 215. In response to the clock signal and signals at output 255, state machines 245 generate time coordinated requests to each of the readers/decoders 100 and 105 at output 260 and 265, respectively, which the readers/decoders use to initiate reading of the respective visual indicia and transmission of the resulting data to the legacy processing unit number 215. State machines 245 also generate legacy signals at output 270, which are provided to the input of legacy processing unit 215 to mimic the operation of the components of the legacy system that have been replaced by updated system 210.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A sample identification system comprising:
a first optical reader having a first field of view sufficient to expose the first optical reader to targeted visual indicia identifying a carrier, the carrier having one or more compartments for holding at least one sample tube therein;
a second optical reader having a second field of view sufficient to expose the second optical reader to targeted visual indicia identifying a sample tube held by the carrier;
a process controller adapted to direct manipulation of the content of the sample tube based on identification data derived from the first and second optical readers.

2. A sample identification system as claimed in claim 1 and further comprising:
a first mask positioned within the first field of view of the first optical reader to limit exposure of the first optical reader to the targeted visual indicia identifying the carrier to the exclusion of other visual indicia proximate the targeted visual indicia identifying the carrier;
a second mask positioned within the second field of view of the second optical reader to limit exposure of the second optical reader to the targeted visual indicia identifying the sample tube to the exclusion of other visual indicia proximate the targeted visual indicia identifying the sample tube.

3. A sample identification system as claimed in claim 1 wherein the first and second optical readers comprise area scan cameras.

4. A sample identification system as claimed in claim 3 wherein the visual indicia identifying the carrier and the visual indicia identifying the sample tube comprise barcodes.

5. A sample identification system as claimed in claim 4 and further comprising an image decoder adapted to provide a digital electronic identification signal based on area scan images provided by the first and second optical readers.

6. A sample identification system comprising:
a first optical reader having a first field of view sufficient to expose the first optical reader to targeted visual indicia identifying a carrier, the carrier having one or more compartments for holding at least one sample tube therein;
a second optical reader having a second field of view sufficient to expose the second optical reader to targeted visual indicia identifying a sample tube held by the carrier;
one or more decoders adapted to provide digital electronic identification signals based on the output signals from the first and second optical readers.

7. A sample identification system as claimed in claim 6 wherein the first and second readers comprise area scan cameras.

8. A sample identification system as claimed in claim 6 wherein the visual indicia identifying the carrier and the visual indicia identifying the sample tube comprise barcodes.

9. A sample identification system as claimed in claim 7 wherein the visual indicia identifying the carrier and the visual indicia identifying the sample tube comprise barcodes.

10. A sample identification system as claimed in claim 6 and further comprising:
a first mask positioned within the first field of view of the first optical reader to limit exposure of the first optical reader to the targeted visual indicia identifying the carrier to the exclusion of other visual indicia proximate the targeted visual indicia identifying the carrier;
a second mask positioned within the second field of view of the second optical reader to limit exposure of the second optical reader to the targeted visual indicia identifying the sample tube to the exclusion of other visual indicia proximate the targeted visual indicia identifying the sample tube.

11. A sample identification system as claimed in claim 8 wherein the decoder extracts barcode information from an area scan image acquired by the first optical reader, the decoder providing a digitally encoded signal output corresponding to the barcode for the carrier.

12. A sample identification system as claimed in claim 8 wherein the decoder extracts barcode information from an area scan image acquired by the second optical reader, the decoder providing a digitally encoded signal output corresponding to the barcode for the sample tube.

13. A sample identification system as claimed in claim 11 wherein at least one of the decoders extracts barcode information from an area scan image acquired by the second optical reader, the further digitally encoded signal output corresponding to the barcode for the sample tube.

14. A sample identification system as claimed in claim 13 wherein the digitally encoded signal output corresponding to the barcode for the carrier and the further digitally encoded signal output corresponding to the barcode for the sample tube are provided in a serial data stream to a processing unit.

15. A sample identification system as claimed in claim 14 wherein the processing unit uses the serial data stream to control processing of the content of the identified sample tube.

16. A sample identification system comprising:
a support bracket;
a first optical reader in fixed relation with the support bracket, the first optical reader having a first field of view sufficient to expose the first optical reader to targeted visual indicia identifying a carrier, the carrier having one or more compartments for holding at least one sample tube therein;
a second optical reader in fixed relation with the support bracket, the second optical reader having a second field of view sufficient to expose the second optical reader to targeted visual indicia identifying a sample tube held by the carrier;
a first mask positioned to limit exposure of the first optical reader to the targeted visual indicia identifying the carrier to the exclusion of other visual indicia proximate the targeted visual indicia identifying the carrier;
a second mask positioned limit exposure of the second optical reader to the targeted visual indicia identifying the sample tube to the exclusion of other visual indicia proximate the targeted visual indicia identifying the sample tube.

17. A sample identification system as claimed in claim 16 wherein the support bracket is adapted for connection to a frame member, the support bracket being movable between an operative position and a service position when connected to the frame member.

18. A sample identification system as claimed in claim 16 and further comprising one or more decoders adapted to provide digital electronic identification signals corresponding to the sample tube based on the output signals from the first and second optical readers.

19. A sample identification system as claimed in claim 18 wherein the first and second optical readers comprise area scan cameras.

20. A sample identification system as claimed in claim 19 wherein at least one of the decoders extracts barcode information from an area scan image acquired by the first optical reader, the at least one decoder providing a digitally encoded signal output corresponding to the barcode for the carrier.

21. A sample identification system as claimed in claim 19 wherein at least one of the decoders extracts barcode information from an area scan image acquired by the second optical reader, the at least one decoder providing a digitally encoded signal output corresponding to the barcode for the sample tube.

22. A sample identification system as claimed in claim 21 wherein the at least one decoder extracts barcode information from an area scan image acquired by the second reader, the at least one decoder providing a further digitally encoded signal output corresponding to the barcode for the sample tube.

23. A sample identification system as claimed in claim 22 wherein the digitally encoded signal output corresponding to the barcode for the carrier and the further digitally encoded signal output corresponding to the barcode for the sample tube are provided in a serial data stream to a process controller.

24. A sample identification system as claimed in claim 14 wherein the process controller uses the serial data stream to direct manipulation of the content of identified sample tubes.

25. A sample identification unit for use in retrofitting a legacy sample processing system, the sample identification unit comprising:
a support bracket adapted for connection to one or more existing frame members of the legacy sample processing system;
a first optical reader in fixed relation with the support bracket, the first optical reader having a first field of view sufficient to expose the first optical reader to targeted visual indicia identifying a carrier, the carrier having one or more compartments for holding at least one sample tube therein;
a second optical reader in fixed relation with the support bracket, the second optical reader having a second field of view sufficient to expose the second optical reader to targeted visual indicia identifying a sample tube held by the carrier;
an interface controller adapted to convert identification data obtained via the first and second optical readers to a digital data format suitable for use by a legacy process controller of the legacy sample processing system.

26. A sample identification unit as claimed in claim 25 and further comprising a housing connected to the support bracket, the first and second optical readers being mounted within the housing.

27. A sample identification unit as claimed in claim 26 wherein the interface controller is disposed within the housing.

28. A sample identification unit as claimed in claim 26 wherein the interface controller is disposed exterior to the housing.

29. A sample identification unit as claimed in claim 25 and further comprising:
a first mask in fixed relationship with the support bracket and positioned with respect to the first optical reader to limit exposure of the first optical reader to the targeted visual indicia identifying the carrier to the exclusion of other visual indicia proximate the targeted visual indicia identifying the carrier;
a second mask in fixed relationship with the support bracket and positioned within the second field of view to limit exposure of the second optical reader to the targeted visual indicia identifying the sample tube to the exclusion of other visual indicia proximate the targeted visual indicia identifying the sample tube.

30. A sample identification system as claimed in claim 26 wherein the first and second optical readers comprise cameras.

31. A sample identification system as claimed in claim 30 wherein the visual indicia identifying the carrier and the visual indicia identifying the sample tube comprise barcodes.

32. A sample identification unit as claimed in claim 26 wherein the support bracket is adapted for movement between an operative position and a service position when attached to the legacy processing system.
